(19) United States
(12) Patent Application Publication
(10) Pub. No.: US 2019/0190080 A1
(43) Pub. Date: Jun. 20, 2019

(54) NONAQUEOUS ELECTROLYTE SECONDARY BATTERY

(71) Applicant: Sumitomo Chemical Company, Limited, Tokyo (JP)

(72) Inventors: Ichiro ARISE, Osaka (JP); Toshihiko OGATA, Osaka (JP); Kosuke KURAKANE, Osaka (JP); Junji SUZUKI, Osaka (JP)

(21) Appl. No.: 16/224,803

(22) Filed: Dec. 19, 2018

(30) Foreign Application Priority Data
Dec. 19, 2017 (JP) 2017-243283

(51) Int. Cl. H01M 10/0585; H01M 2/16; H01M 4/131; H01M 4/133; H01M 4/583; H01M 4/48

(52) U.S. Cl. CPC H01M 10/0585; H01M 2/16; H01M 4/131; H01M 10/0525; H01M 4/583; H01M 4/48; H01M 4/133

(57) ABSTRACT

A nonaqueous electrolyte secondary battery in accordance with an embodiment of the present invention includes: a separator including a polyolefin porous film; a porous layer containing a polyvinylidene fluoride-based resin; a positive electrode plate, a bend number of which being not less than 130, the bend number indicating how many times the positive electrode plate bends before peeling of a positive electrode active material layer occurs; and a negative electrode plate, a bend number of which being not less than 1650, the bend number indicating how many times the negative electrode plate bends before peeling of a negative electrode active material layer occurs, the polyvinylidene fluoride-based resin containing not less than 35.0 mol % of an α-form polyvinylidene fluoride-based resin.

This Nonprovisional application claims priority under 35 U.S.C. § 119 on Patent Application No. 2017-243283 filed in Japan on Dec. 19, 2017, the entire contents of which are hereby incorporated by reference.

### TECHNICAL FIELD

The present invention relates to a nonaqueous electrolyte secondary battery.

### BACKGROUND ART

Nonaqueous electrolyte secondary batteries, particularly lithium secondary batteries, have a high energy density, and are therefore in wide use as batteries for use in devices such as a personal computer, a mobile telephone, and a portable information terminal. Such lithium secondary batteries have recently been developed as on-vehicle batteries.

For example, Patent Literature 1 discloses a nonaqueous electrolyte secondary battery including a polyolefin porous film and a porous layer containing a polyvinylidene fluoride-based resin.

### CITATION LIST

### Patent Literature

[Patent Literature 1] Japanese Patent No. 5432417 (Registered on Dec. 13, 2013)

### SUMMARY OF INVENTION

### Technical Problem

There has been a room for improvement in the above conventional nonaqueous electrolyte secondary battery including a polyolefin porous film and a porous layer containing a polyvinylidene fluoride-based resin, in terms of a charge capacity characteristic after high-rate discharge subsequent to repeated high-rate charge and discharge cycles.

An object of an aspect of the present invention is to provide a nonaqueous electrolyte secondary battery which has an excellent charge capacity characteristic after high-rate discharge subsequent to repeated high-rate charge and discharge cycles.

### Solution to Problem

A nonaqueous electrolyte secondary battery in accordance with Aspect 1 of the present invention includes: a nonaqueous electrolyte secondary battery separator including a polyolefin porous film; a porous layer containing a polyvinylidene fluoride-based resin; a positive electrode plate, a bend number of which being not less than 130, the bend number indicating how many times the positive electrode plate bends before peeling of a positive electrode active material layer occurs in a folding endurance test according to an MIT tester method specified in JIS P 8115 (1994), the folding endurance test being carried out under conditions of a load of 1 N and a bending angle of 45°; and a negative electrode plate, a bend number of which being not less than 1650, the bend number indicating how many times the negative electrode plate bends before peeling of a negative electrode active material layer occurs in the folding endurance test, the porous layer being provided between the nonaqueous electrolyte secondary battery separator and at least one of the positive electrode plate and the negative electrode plate, the polyvinylidene fluoride-based resin contained in the porous layer containing an α-form polyvinylidene fluoride-based resin and a β-form polyvinylidene fluoride-based resin, a content of the α-form polyvinylidene fluoride-based resin being not less than 35.0 mol % with respect to 100 mol % of a total content of the α-form polyvinylidene fluoride-based resin and the β-form polyvinylidene fluoride-based resin in the polyvinylidene fluoride-based resin, the content of the α-form polyvinylidene fluoride-based resin being calculated by (a) waveform separation of (α/2) observed at around −78 ppm in a ¹⁹F-NMR spectrum obtained from the porous layer and (b) waveform separation of {(α/2)+β} observed at around −95 ppm in the ¹⁹F-NMR spectrum obtained from the porous layer.

Further, a nonaqueous electrolyte secondary battery in accordance with Aspect 2 of the present invention is arranged such that in the above Aspect 1, the positive electrode plate contains a transition metal oxide.

Further, a nonaqueous electrolyte secondary battery in accordance with Aspect 3 of the present invention is arranged such that in the above Aspect 1 or 2, the negative electrode plate contains graphite.

Further, a nonaqueous electrolyte secondary battery in accordance with Aspect 4 of the present invention is arranged to further include, in any one of Aspects 1 through 3, another porous layer which is provided between (i) the nonaqueous electrolyte secondary battery separator and (ii) at least one of the positive electrode plate and the negative electrode plate.

Further, a nonaqueous electrolyte secondary battery in accordance with Aspect 5 of the present invention is arranged such that in Aspect 4, the another porous layer contains at least one kind of resin selected from the group consisting of polyolefins, (meth)acrylate-based resins, fluorine-containing resins (excluding polyvinylidene fluoride-based resins), polyamide-based resins, polyester-based resins and water-soluble polymers.

Further, a nonaqueous electrolyte secondary battery in accordance with Aspect 6 of the present invention is arranged such that in Aspect 5, the polyamide-based resin is an aramid resin.

### Advantageous Effects of Invention

An aspect of the present invention makes it possible to provide a nonaqueous electrolyte secondary battery which has an excellent charge capacity characteristic after high-rate discharge subsequent to repeated high-rate charge and discharge cycles.

### BRIEF DESCRIPTION OF DRAWINGS

FIG. 1 is a diagram schematically illustrating an MIT tester.

### DESCRIPTION OF EMBODIMENTS

The following description will discuss an embodiment of the present invention. Note, however, that the present invention is not limited to the embodiment. The present invention is not limited to arrangements described below, but may be altered in various ways by a skilled person within the scope of the claims. Any embodiment based on a proper combination of technical means disclosed in different embodiments is also encompassed in the technical scope of the present invention. Note that a numerical expression “A to B” herein means “not less than A and not more than B” unless otherwise stated.

A nonaqueous electrolyte secondary battery in accordance with an embodiment of the present invention includes: a separator for a nonaqueous electrolyte secondary battery (hereinafter, also referred to as “nonaqueous electrolyte secondary battery separator” or “separator”) including a polyolefin porous film; a porous layer containing a polyvinylidene fluoride-based resin (hereinafter, also referred to as “PVDF-based resin”); a positive electrode plate, a bend number of which being not less than 130, the bend number indicating how many times the positive electrode plate bends before peeling of a positive electrode active material layer occurs in a folding endurance test according to an MIT tester method specified in JIS P 8115 (1994), the folding endurance test being carried out under conditions of a load of 1 N and a bending angle of 45°; and a negative electrode plate, a bend number of which being not less than 1650, the bend number indicating how many times the negative electrode plate bends before peeling of a negative electrode active material layer occurs in the folding endurance test, the porous layer being provided between the nonaqueous electrolyte secondary battery separator and at least one of the positive electrode plate and the negative electrode plate, the polyvinylidene fluoride-based resin contained in the porous layer containing an α-form polyvinylidene fluoride-based resin and a β-form polyvinylidene fluoride-based resin, a content of the α-form polyvinylidene fluoride-based resin being not less than 35.0 mol % with respect to 100 mol % of a total content of the α-form polyvinylidene fluoride-based resin and the β-form polyvinylidene fluoride-based resin in the polyvinylidene fluoride-based resin, the content of the α-form polyvinylidene fluoride-based resin being calculated by (a) waveform separation of (α/2) observed at around −78 ppm in a ¹⁹F-NMR spectrum obtained from the porous layer and (b) waveform separation of {(α/2)+β} observed at around −95 ppm in the ¹⁹F-NMR spectrum obtained from the porous layer.

<Positive Electrode Plate>

The positive electrode plate in the nonaqueous electrolyte secondary battery in accordance with an embodiment of the present invention is not limited to any particular one, provided that the bend number of the positive electrode plate is within a specific range, which bend number is measured in a folding endurance test as described later. For example, a sheet-shaped positive electrode plate used in the nonaqueous electrolyte secondary battery includes (i) a positive electrode mix as a positive electrode active material layer, which positive electrode mix contains a positive electrode active material, an electrically conductive agent, and a binding agent and (ii) a positive electrode current collector supporting the positive electrode mix thereon. Note that the positive electrode plate can be arranged such that the positive electrode current collector supports the positive electrode mix on one surface or each of both surfaces of the positive electrode current collector.

The positive electrode active material is, for example, a material capable of being doped with and dedoped of lithium ions. Such a material is preferably a transition metal oxide. Specific examples of the transition metal oxide include a lithium complex oxide containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and a fired product of an organic polymer compound. It is possible to use only one kind of the above electrically conductive agents or two or more kinds of the above electrically conductive agents in combination.

Examples of the binding agent include: thermoplastic resins such as polyvinylidene fluoride, a copolymer of vinylidene fluoride, polytetrafluoroethylene, a tetrafluoroethylene-hexafluoropropylene copolymer, a tetrafluoroethylene-perfluoroalkyl vinyl ether copolymer, an ethylene-tetraflu or oethylene copolymer, a vinylidene fluoride-hexafluoropropylene copolymer, a vinylidene fluoride-hexafluoropropylene-tetrafluoroethylene copolymer, a thermoplastic polyimide, polyethylene, and polypropylene; an acrylic resin; and styrene-butadiene rubber. Note that the binding agent functions also as a thickener.

Examples of the positive electrode current collector include electric conductors such as Al, Ni, and stainless steel. Among these electric conductors, Al is more preferable because Al is easily processed into a thin film and is inexpensive.

<Negative Electrode Plate>

The negative electrode plate in the nonaqueous electrolyte secondary battery in accordance with an embodiment of the present invention is not limited to any particular one, provided that the bend number of the negative electrode plate is within a specific range, which bend number is measured in a folding endurance test as described later. For example, a sheet-shaped negative electrode plate used in the nonaqueous electrolyte secondary battery includes (i) a negative electrode mix as a negative electrode active material layer, which negative electrode mix contains a negative electrode active material and (ii) a negative electrode current collector supporting the negative electrode mix thereon. The sheet-shaped negative electrode plate preferably contains an electrically conductive agent as described above and a binding agent as described above. Note that the negative electrode plate can be arranged such that the negative electrode current collector supports the negative electrode mix on one surface or each of both surfaces of the negative electrode current collector.

Examples of the negative electrode active material include (i) a material capable of being doped with and dedoped of lithium ions, (ii) lithium metal, and (iii) lithium alloy. Examples of such a material include carbonaceous materials. Examples of the carbonaceous materials include graphite (natural graphite, artificial graphite), cokes, carbon black, and pyrolytic carbons. The electrically conductive agent can be any of the above-described electrically conductive agents which may be contained in the positive electrode active material layer. Meanwhile, the binding agent can be any of the above-described binding agents which may be contained in the positive electrode active material layer.

Examples of the negative electrode current collector include Cu, Ni, and stainless steel. Among these electric conductors, Cu is more preferable because Cu is not easily alloyed with lithium particularly in a lithium-ion secondary battery and is easily processed into a thin film.

<Bend Number>

When the positive electrode plate and the negative electrode plate in an embodiment of the present invention are each subjected to a folding endurance test in conformity with an MIT tester method specified in JIS P 8115(1994) so as to measure (i) how many times the positive electrode plate bends before peeling of a positive electrode active material layer occurs (herein, also referred to as “number of bends before peeling” or “bend number”) and (ii) how many times the negative electrode plate bends before peeling of a negative electrode active material layer occurs (herein, referred to as “number of bends before peeling” or “bend number”), the number of bends of the positive electrode plate and the number of bends of the negative electrode plate are each within a specific range. The folding endurance test is carried out at a load of 1 N and a bending angle of 45°. During a process of charge and discharge cycles, an active material may expand or shrink in the nonaqueous electrolyte secondary battery. With regard to the number of bends before peeling of an electrode active material layer which number of bends is measured in the above-described folding endurance test, when the number of bends is larger, it is easier to keep cohesion of components (active material, electrically conductive agent and binding agent) contained inside the electrode active material layer and it is also easier to keep adhesion between the electrode active material layer and a current collector. This makes it possible to prevent deterioration of the nonaqueous electrolyte secondary battery during the process of charge and discharge cycles.

In the folding endurance test, the number of bends of the positive electrode plate before peeling of the positive electrode active material layer is preferably not less than 130, and more preferably not less than 150. Meanwhile, in the folding endurance test, the number of bends of the negative electrode plate before peeling of the negative electrode active material layer is preferably not less than 1650, more preferably not less than 1800, and still more preferably not less than 2000.

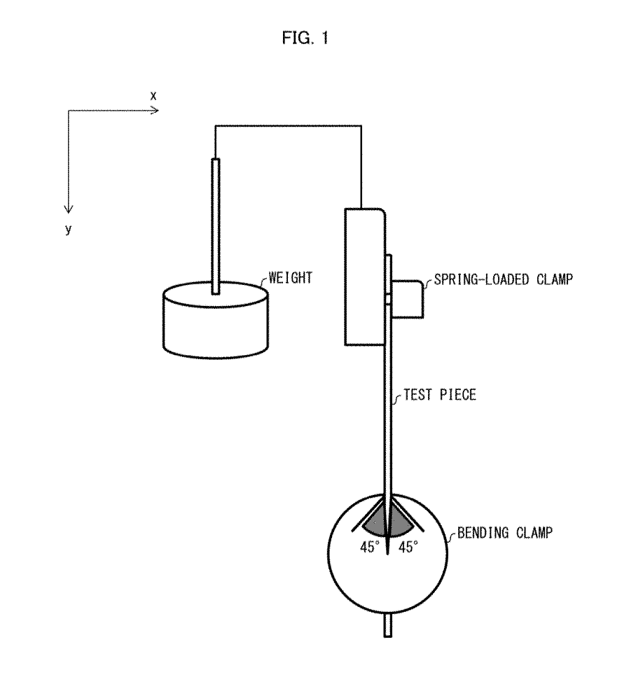

FIG. 1 is a diagram schematically illustrating an MIT tester which is used for the MIT tester method. In FIG. 1, x axis represents a horizontal direction and y axis represents a vertical direction. The following will describe an outline of the MIT tester method. The MIT tester includes a spring-loaded clamp and a bending clamp. One longitudinal end of a test piece is clamped by the spring-loaded clamp, while the other longitudinal end of the test piece is clamped by the bending clamp. The test piece is thereby fixed. The spring-loaded clamp is connected with a weight. In the above folding endurance test, a load of 1 N is applied by the weight. Tension is thus being applied to the test piece in a longitudinal direction of the test piece. In this state, the longitudinal direction of the test piece is parallel to the vertical direction. The bending clamp is then rotated so that the test piece is bent. In the above folding endurance test, a bending angle in this bending is 45°. In other words, the test piece is bent to right by 45° and left by 45° with respect to the vertical direction. When the test piece is bent to right and left, a bending speed is 175 reciprocations/min.

<Method of Producing Positive Electrode Plate and Negative Electrode Plate>

Examples of a method of producing the sheet-shaped positive electrode plate include: a method in which a positive electrode active material, an electrically conductive agent, and a binding agent are pressure-molded on a positive electrode current collector; and a method in which (i) a positive electrode active material, an electrically conductive agent, and a binding agent are formed into a paste with use of a suitable organic solvent, (ii) then, a positive electrode current collector is coated with the paste, and (iii) subsequently, the paste in a moist state or after drying is pressured so that the paste is firmly fixed to the positive electrode current collector.

Similarly, examples of a method of producing the sheet-shaped negative electrode plate include: a method in which a negative electrode active material is pressure-molded on a negative electrode current collector; and a method in which (i) a negative electrode active material is formed into a paste with use of a suitable organic solvent, (ii) then, a negative electrode current collector is coated with the paste, and (iii) subsequently, the paste in a moist state or after drying is pressured so that the paste is firmly fixed to the negative electrode current collector. The paste preferably contains an electrically conductive agent as described above and a binding agent as described above.

The above-described number of bends can be controlled by further applying pressure to the positive electrode plate or negative electrode plate which has been obtained as above. Specifically, a time length for applying pressure, a pressure value, a method of applying the pressure, etc. are adjusted, so that the above-described number of bends can be controlled. The time length for applying pressure is preferably 1 second to 3600 seconds, and more preferably 1 second to 300 seconds. The pressure may be applied by confining the positive electrode plate or the negative electrode plate. The pressure caused by such confining is herein also called “confining pressure”. The confining pressure is preferably 0.01 MPa to 10 MPa, and more preferably 0.01 MPa to 5 MPa. Further, the pressure may be applied while the positive electrode plate or the negative electrode plate is wet with an organic solvent. This may increase cohesion of components contained inside the electrode active material layer and adhesion between the electrode active material layer and the current collector. Examples of the organic solvent include carbonates, ethers, esters, nitriles, amides, carbamates, and sulfur-containing compounds, and fluorine-containing organic solvents each obtained by introducing a fluorine group into any of these organic solvents.

<Nonaqueous Electrolyte Secondary Battery Separator>

The nonaqueous electrolyte secondary battery separator for an embodiment of the present invention includes a polyolefin porous film. Note that in the following description, the polyolefin porous film may also be referred to as “porous film”.

The porous film alone can be a nonaqueous electrolyte secondary battery separator. Further, the porous film can be a base material for a laminated separator for a nonaqueous electrolyte secondary battery (hereinafter referred to as “nonaqueous electrolyte secondary battery laminated separator”) in which a porous layer (described later) is provided. The porous film contains a polyolefin-based resin as a main component and has therein many pores connected to one another, so that a gas and a liquid can pass through the polyolefin porous film from one surface to the other.

In the nonaqueous electrolyte secondary battery separator for an embodiment of the present invention, a porous layer containing a polyvinylidene fluoride-based resin (described later) can be disposed on at least one surface of the nonaqueous electrolyte secondary battery separator. In this case, a laminated body including the porous layer disposed on at least one surface of the nonaqueous electrolyte secondary battery separator is herein referred to as “nonaqueous electrolyte secondary battery laminated separator” or “laminated separator.” A nonaqueous electrolyte secondary battery separator for an embodiment of the present invention may further include another layer(s) such as an adhesive layer, a heat-resistant layer, a protective layer, and/or the like, in addition to the polyolefin porous film.

(Polyolefin Porous Film)

The porous film contains polyolefin in a proportion of not less than 50% by volume, preferably not less than 90% by volume, and more preferably not less than 95% by volume, with respect to a whole of the porous film. The polyolefin more preferably contains a high molecular weight component having a weight-average molecular weight of 5×10⁵ to 15×10⁶. In particular, the polyolefin more preferably contains a high molecular weight component having a weight-average molecular weight of not less than 1,000,000 because a strength of a resultant nonaqueous electrolyte secondary battery separator improves.

Specific examples of the polyolefin which is a thermoplastic resin include homopolymers and copolymers which are each obtained by polymerizing a monomer(s) such as ethylene, propylene, 1-butene, 4-methyl-1-pentene, 1-hexene, and/or the like. Specifically, examples of such homopolymers include polyethylene, polypropylene, and polybutene. Meanwhile, examples of such copolymers include an ethylene-propylene copolymer.

Among the above polyolefins, polyethylene is more preferable because it is possible to prevent (shut down) a flow of an excessively large electric current at a lower temperature. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these polyethylenes, ultra-high molecular weight polyethylene having a weight-average molecular weight of not less than 1,000,000 is still more preferable.

The porous film has a thickness of preferably 4 μm to 40 μm, more preferably 5 μm to 30 μm, and still more preferably 6 μm to 15 μm.

The porous film has a weight per unit area which weight should be set as appropriate in view of strength, a thickness, a weight, and handleability of the porous film. Note, however, that the weight per unit area of the porous film is preferably 4 g/m² to 20 g/m², more preferably 4 g/m² to 12 g/m², and still more preferably 5 g/m² to 10 g/m², so as to allow the nonaqueous electrolyte secondary battery to have a higher weight energy density and a higher volume energy density.

The porous film has an air permeability of preferably 30 sec/100 mL to 500 sec/100 mL, and more preferably 50 sec/100 mL to 300 sec/100 mL, in terms of Gurley values. A porous film having the above air permeability can achieve sufficient ion permeability.

The porous film has a porosity of preferably 20% by volume to 80% by volume, and more preferably 30% by volume to 75% by volume, so as to (i) retain an electrolyte in a larger amount and (ii) obtain a function of reliably preventing (shutting down) a flow of an excessively large electric current at a lower temperature. Further, in order to achieve sufficient ion permeability and prevent particles from entering the positive electrode and/or the negative electrode, the porous film has pores each having a pore size of preferably not more than 0.3 μm, and more preferably not more than 0.14 μm.

With regard to a whiteness index (WI) defined in American Standard Test Methods (hereinafter, abbreviated as “ASTM”) E313 (hereinafter, also referred to simply as “WI”), the porous film has a WI value of preferably not less than 85 and not more than 98. A lower limit of the WI value is more preferably not less than 90, while an upper limit of the WI value is more preferably not more than 97.

The WI is an indicator of a color tone (whiteness) of a sample, and is used to indicate, (i) the fading characteristic of a dye and (ii) the degree of oxidation degradation in transparent or white resin being processed. A higher WI value means a higher degree of whiteness. In contrast, a lower WI value means a lower degree of whiteness. Further, a lower WI value presumably means a larger amount of functional groups such as a carboxy group at a surface of the porous film which surface is in contact with air (oxygen) (e.g., a surface of each pore of the porous film). Such functional groups prevent permeation of Li ions, and lead to a lower ion permeability. On the other hand, when a porous film has a high WI value, wavelength dependency of reflection and scattering is low in the porous film.

The porous film can be produced by, for example, (i) a method of obtaining a porous film by adding a filler (pore forming agent) to a resin such as polyolefin, shaping the resin into a sheet, then removing the filler with use of an appropriate solvent, and stretching the sheet from which the filler has been removed, or (ii) a method of obtaining a porous film by adding a filler to a resin such as polyolefin, shaping the resin into a sheet, then stretching the sheet, and removing the filler from the sheet thus stretched. This means that a resultant porous film normally does not contain a filler.

The inventor of the present invention has found that a porous film can have a WI value of not less than 85 and not more than 98 in a case where (i) generation of a functional group such as a carboxyl group is prevented by using, during production of the porous film, a filler having a large BET specific surface area to allow for an increase in dispersibility of the filler and to consequently prevent local oxidation degradation caused by defective dispersion of the filler during heat processing, and (ii) the porous film is made denser.

The “filler having a large BET specific surface area” refers to a filler having a BET specific surface area of not less than 6 m²/g and not more than 16 m²/g. A filler having a BET specific surface area of less than 6 m²/g is not preferable. This is because such a filler tends to cause large-sized pores to be developed. A filler having a BET specific surface area of more than 16 m²/g causes agglomeration of the filler and leads to defective dispersion of the filler, so that dense pores are less likely to be developed. Therefore, the filler has a BET specific surface area of preferably not less than 8 m²/g and not more than 15 m²/g, and more preferably not less than 10 m²/g and not more than 13 m²/g.

Specific examples of the filler include fillers made of inorganic matters such as calcium carbonate, magnesium carbonate, barium carbonate, calcium sulfate, magnesium sulfate, and barium sulfate. It is possible to use only one kind of the above fillers or two or more kinds of the above fillers in combination. Among the above fillers, a filler made of calcium carbonate is particularly preferable from the viewpoint of its large BET specific surface area.

Whether the porous film has a WI value of not less than 85 and not more than 98 can be determined through, for example, measurement of WI values with use of an integrating-sphere spectrocolorimeter. The porous film described above has a front surface and a back surface both of which satisfy the requirement that the WI value is not less than 85 and not more than 98.

A porous film having a WI value of not less than 85 and not more than 98 achieves an appropriate amount of functional groups such as a carboxy group at the surface of the porous film which surface is in contact with air (oxygen). This makes it possible to increase the ion permeability of the porous film within an appropriate range.

On the other hand, a porous film having a WI value of less than 85 results in a large amount of the functional groups. This reduces the ion permeability of the porous film.

In contrast, a porous film having a WI value of more than 98 results in a too small amount of the functional groups at the surface of the porous film which surface is in contact with air (oxygen). This decreases the compatibility of the porous film with electrolyte. Therefore, such a porous film is undesirable.

In a case where a porous layer and/or another layer other than the porous layer is disposed on the porous film, physical property values of such a porous film can be measured by the porous film isolated by removing the porous layer and/or the another layer from a laminated body including the porous film, and the porous layer and/or the another layer. The porous layer and/or the another layer can be removed from the laminated body by, for example, a method in which a resin(s) constituting the porous layer and/or the another layer is/are dissolved with use of a solvent such as N-methylpyrrolidone or acetone for removal.

<Porous Layer>

In an embodiment of the present invention, the porous layer is provided, as a constituent member of the nonaqueous electrolyte secondary battery, between the nonaqueous electrolyte secondary battery separator and at least one of the positive electrode plate and the negative electrode plate. The porous layer can be provided on one surface or each of both surfaces of the nonaqueous electrolyte secondary battery separator. Alternatively, the porous layer can be provided on an active material layer of at least one of the positive electrode plate and the negative electrode plate. Alternatively, the porous layer can be provided between the nonaqueous electrolyte secondary battery separator and at least one of the positive electrode plate and the negative electrode plate so as to be in contact with the nonaqueous electrolyte secondary battery separator and the positive electrode plate or the negative electrode plate. The porous layer may be provided so as to form one layer or two or more layers, between the nonaqueous electrolyte secondary battery separator and at least one of the positive electrode plate and the negative electrode plate.

The porous layer is preferably an insulating porous layer containing a resin.

The resin which can be contained in the insulating porous layer is preferably a resin that is insoluble in the electrolyte of the battery and that is electrochemically stable when the battery is in normal use. In a case where the porous layer is disposed on one surface of the porous film, the porous layer is disposed preferably on a surface of the porous film which surface faces the positive electrode plate of the nonaqueous electrolyte secondary battery, more preferably on a surface of the porous film which surface is in contact with the positive electrode plate.

The porous layer for an embodiment of the present invention contains a PVDF-based resin, which contains a PVDF-based resin having crystal forma (hereinafter, referred to as “α-form PVDF-based resin”) in a content of not less than 35.0 mol % with respect to 100 mol % of the total content of the α-form PVDF-based resin and a PVDF-based resin having crystal form β (hereinafter, referred to as “β-form PVDF-based resin”) in the PVDF-based resin.

The content of the α-form PVDF-based resin is calculated by (a) waveform separation of (α/2) observed at around −78 ppm in a ¹⁹F-NMR spectrum obtained from the porous layer and (b) waveform separation of {(α/2)+β} observed at around −95 ppm in the ¹⁹F-NMR spectrum obtained from the porous layer.

The porous layer has a structure in which many pores connected to one another are provided. Accordingly, the porous layer is a layer through which a gas or a liquid can pass from one surface to the other. Further, in a case where the porous layer for an embodiment of the present invention is used as a constituent member of a nonaqueous electrolyte secondary battery laminated separator, the porous layer can be a layer which, serving as an outermost layer of the laminated separator, comes in contact with an electrode.

Examples of the PVDF-based resin include homopolymers of vinylidene fluoride; copolymers of vinylidene fluoride and other monomer(s) polymerizable with vinylidene fluoride; and mixtures of the above polymers. Examples of the monomer polymerizable with vinylidene fluoride include hexafluoropropylene, tetrafluoroethylene, trifluoroethylene, trichloroethylene, and vinyl fluoride. It is possible to use one kind of monomer or two or more kinds of monomers selected from above monomers. The PVDF-based resin can be synthesized through emulsion polymerization or suspension polymerization.

The PVDF-based resin contains, as a constituent unit, vinylidene fluoride in a proportion of normally not less than 85 mol %, preferably not less than 90 mol %, more preferably not less than 95 mol %, and further preferably not less than 98 mol %. A PVDF-based resin containing vinylidene fluoride in a proportion of not less than 85 mol % is more likely to allow a porous layer to have a mechanical strength against pressure and a heat resistance against heat during battery production.

The porous layer can also preferably contain two kinds of PVDF-based resins (that is, a first resin and a second resin below) that differ from each other in terms of, for example, the hexafluoropropylene content.
The first resin is (i) a vinylidene fluoride-hexafluoropropylene copolymer containing hexafluoropropylene in a proportion of more than 0 mol % and not more than 1.5 mol % or (ii) a vinylidene fluoride homopolymer.
The second resin is a vinylidene fluoride-hexafluoropropylene copolymer containing hexafluoropropylene in a proportion of more than 1.5 mol %.

A porous layer containing the two kinds of PVDF-based resins adheres better to an electrode than a porous layer not containing one of the two kinds of PVDF-based resins. Further, a porous layer containing the two kinds of PVDF-based resins adheres better to another layer (for example, a layer of the porous film) included in a nonaqueous electrolyte secondary battery separator than a porous layer not containing one of the two kinds of PVDF-based resins. This allows the porous layer containing the two kinds of PVDF-based resin to have a higher peel strength between the porous layer and the another layer, as compared to a porous layer not containing one of the two kinds of PVDF-based resins. The first resin and the second resin are preferably at a mass ratio (first resin:second resin) of 15:85 to 85:15.

The weight-average molecular weight of the PVDF-based resin is preferably 200,000 to 3,000,000, more preferably 200,000 to 2,000,000, still more preferably 500,000 to 1,500,000. A PVDF-based resin having a weight-average molecular weight of not less than 200,000 tends to allow the porous layer and the electrode to sufficiently adhere to each other. On the other hand, a PVDF-based resin having a weight-average molecular weight of not more than 3,000,000 tends to have excellent shaping easiness.

The porous layer may contain, as a resin other than the PVDF-based resin, for example, any of styrene-butadiene copolymers; homopolymers or copolymers of vinyl nitriles such as acrylonitrile and methacrylonitrile; and polyethers such as polyethylene oxide and polypropylene oxide.

The porous layer for an embodiment of the present invention may contain a filler such as an inorganic filler (e.g., metal oxide fine particles etc.) or an organic filler. The filler is contained in a proportion of preferably not less than 1% by mass and not more than 99% by mass, and more preferably not less than 10% by mass and not more than 98% by mass, with respect to the total amount of the PVDF-based resin and the filler. A lower limit of the proportion of the filler may be not less than 50% by mass, not less than 70% by mass, or not less than 90% by mass. The filler such as an organic filler or an inorganic filler can be a conventionally known filler.

The porous layer has an average thickness of preferably 0.5 μm to 10 μm per layer, and more preferably 1 μm to 5 μm per layer in order to ensure adhesion of the porous layer to an electrode and a high energy density.

In a case where the porous layer has a thickness of not less than 0.5 μm per layer, it is possible to sufficiently prevent an internal short circuit caused by, for example, breakage of the nonaqueous electrolyte secondary battery, and also to retain a sufficient amount of the electrolyte in the porous layer.

On the other hand, in a case where the porous layer has a thickness of more than 10 μm per layer, the nonaqueous electrolyte secondary battery has an increased resistance to permeation of lithium ions. Thus, repeating charge and discharge cycles will degrade the positive electrode of the nonaqueous electrolyte secondary battery. This leads to a decreased rate characteristic and a decreased cycle characteristic. Further, such a porous layer has an increased distance between the positive electrode and the negative electrode. This leads to a decreased internal volume efficiency of the nonaqueous electrolyte secondary battery.

The porous layer for an embodiment of the present invention is preferably provided between the nonaqueous electrolyte secondary battery separator and the positive electrode active material layer which is included in the positive electrode plate. In the following description of physical properties of the porous layer, the physical properties of the porous layer means at least physical properties of a porous layer which is disposed between the nonaqueous electrolyte secondary battery separator and the positive electrode active material layer which is included in the positive electrode plate in a resultant nonaqueous electrolyte secondary battery.

The porous layer has a weight per unit area (per layer) which weight should be set as appropriate in view of strength, a thickness, a weight, and handleability of the porous layer. The weight per unit area of the porous layer is preferably 0.5 g/m² to 20 g/m² per layer and more preferably 0.5 g/m² to 10 g/m² per layer.

A porous layer having a weight per unit area (per layer) within the above numerical range allows a nonaqueous electrolyte secondary battery including the porous layer to have a higher weight energy density and a higher volume energy density. In a case where the weight per unit area of the porous layer is beyond the above range, a nonaqueous electrolyte secondary battery including the porous layer will be heavy.

The porous layer has a porosity of preferably 20% by volume to 90% by volume, and more preferably 30% by volume to 80% by volume, in order to achieve sufficient ion permeability. The pores in the porous layer have a diameter of preferably not more than 1.0 μm, and more preferably not more than 0.5 μm. In a case where the pores each have such a diameter, a nonaqueous electrolyte secondary battery that includes the porous layer can achieve sufficient ion permeability.

A nonaqueous electrolyte secondary battery laminated separator including the porous layer has an air permeability of preferably 30 sec/100 mL to 1000 sec/100 mL, and more preferably 50 sec/100 mL to 800 sec/100 mL, in terms of Gurley values. The nonaqueous electrolyte secondary battery laminated separator having such an air permeability can achieve sufficient ion permeability in a nonaqueous electrolyte secondary battery.

In a case where the air permeability is lower than the above range, the nonaqueous electrolyte secondary battery laminated separator has a high porosity and thus has a coarse laminated structure. This may result in a decreased strength of the nonaqueous electrolyte secondary battery laminated separator, and thus lead to insufficient shape stability particularly at high temperatures. On the other hand, in a case where the air permeability is higher than the above range, the nonaqueous electrolyte secondary battery laminated separator may not be able to achieve sufficient ion permeability. This may degrade the battery characteristics of the nonaqueous electrolyte secondary battery.

(Crystal Forms of PVDF-Based Resin)

The PVDF-based resin contained in the porous layer for an embodiment of the present invention contains an α-form PVDF-based resin in a content of not less than 35.0 mol %, preferably not less than 37.0 mol %, more preferably not less than 40.0 mol %, and still more preferably not less than 44.0 mol % with respect to 100 mol % of the total content of the α-form PVDF-based resin and the β-form PVDF-based resin in the PVDF-based resin. Further, the α-form PVDF-based resin is contained preferably in a content of not more than 90.0 mol %. The porous layer containing the α-form PVDF-based resin in a content within the above range can be suitably used as a constituent member of a nonaqueous electrolyte secondary battery which has an excellent charge capacity characteristic after high-rate discharge subsequent to repeated high-rate charge and discharge cycles.

The nonaqueous electrolyte secondary battery generates heat due to internal resistance of the battery when the battery is charged or discharged. A larger current, that is, a higher rate condition leads to generation of a larger amount of heat. When charge and discharge are repeated, the temperature of the battery will further increase. With regard to the melting point of the PVDF-based resin, the melting point of the α-form PVDF-based resin is higher than that of the β-form PVDF-based resin. Accordingly, plastic deformation due to heat less occurs in the α-form PVDF-based resin than in the β-form PVDF-based resin.

In the porous layer for an embodiment of the present invention, a proportion of the α-form PVDF-based resin of the PVDF-based resin constituting the porous layer is arranged to be not lower than a certain level. This makes it possible to decrease, in charge and discharge, deformation of an internal structure of the porous layer, blockage of pores, and/or the like each caused by deformation of the PVDF-based resin due to heat generation particularly during an operation under a high rate condition or due to heat generation during repetition of charge and discharge. Further, it is possible to prevent Li ions from being unevenly distributed due to interaction between the Li ions and the PVDF-based resin. This consequently makes it possible to prevent deterioration of battery performance.

The α-form PVDF-based resin is characterized by being made of a polymer containing a PVDF skeleton having the following conformation:

(TGTG̅-TYPE CONFORMATION) [Math. 1]

The conformation includes two or more constituent conformations chained consecutively, each of which constituent conformations is arranged such that, with respect to a fluorine atom (or a hydrogen atom) bonded to one carbon atom of a main chain in a molecular chain of the PVDF skeleton, (i) a hydrogen atom (or a fluorine atom) bonded to a neighboring carbon atom in the main chain is in a trans position, which neighboring carbon atom is adjacent to the one carbon atom on one side of the one carbon atom, and (ii) a hydrogen atom (or a fluorine atom) bonded to another neighboring carbon atom in the main chain is in a gauche position (positioned at an angle of 60°), which another neighboring carbon atom is adjacent to the one carbon atom on the other (opposite) side of the one carbon atom. Further, the molecular chain is of the following type:

TGTG̅ [Math. 2]

wherein the respective dipole moments of C—F₂ and C—H₂ bonds each have a component perpendicular to the molecular chain and a component parallel to the molecular chain.

In a ¹⁹F-NMR spectrum of the α-form PVDF-based resin, characteristic peaks appear at around −95 ppm and at around −78 ppm.

The β-form PVDF-based resin is characterized by being made of a polymer containing a PVDF skeleton, in which (i) a fluorine atom and a hydrogen atom are bonded respectively to carbon atoms adjacent to each other in a main chain of a molecular chain of the PVDF skeleton, and (ii) the fluorine atom and the hydrogen atom are arranged in a trans conformation (TT-type conformation). In other words, the β-form PVDF-based resin is characterized by being made of a polymer containing a PVDF skeleton in which a fluorine atom and a hydrogen atom, bonded respectively to adjacent carbon atoms forming a carbon-carbon bond in a main chain, are positioned oppositely at an angle of 180 degrees when viewed in a direction of that carbon-carbon bond.

The β-form PVDF-based resin may be arranged such that the PVDF skeleton has a TT-type conformation in its entirety. Alternatively, the β-form PVDF-based resin may be arranged such that a portion of the PVDF skeleton has the TT-type conformation and that the PVDF skeleton has a molecular chain of the TT-type conformation in at least four consecutive PVDF monomer units. In either case, in the TT-type conformation, (i) the carbon-carbon bond, which constitutes a TT backbone, has a planar zigzag structure, and (ii) the respective dipole moments of C—F₂ and C—H₂ bonds each have a component perpendicular to the molecular chain.

In a ¹⁹F-NMR spectrum of the β-form PVDF-based resin, a characteristic peak appears at around −95 ppm.

(Method of Calculating Content Ratios of α-Form PVDF-Based Resin and β-Form PVDF-Based Resin in PVDF-Based Resin)

A content ratio of the α-form PVDF-based resin and a content ratio of the β-form PVDF-based resin are ratios with respect to 100 mol % of the total content of the α-form PVDF-based resin and the β-form PVDF-based resin in the porous layer for the an embodiment of present invention. The content ratio of the α-form PVDF-based resin and the content ratio of the β-form PVDF-based resin can be calculated from a ¹⁹F-NMR spectrum obtained from the porous layer. Specifically, the content ratio of the α-form PVDF-based resin and the content ratio of the β-form PVDF-based resin can be calculated, for example, as follows.

(1) An ¹⁹F-NMR spectrum is obtained from a porous layer containing a PVDF-based resin, under the following conditions.

### Measurement Conditions

Measurement device: AVANCE400 manufactured by Bruker Biospin

Measurement method: single-pulse method

Observed nucleus: ¹⁹F

Spectral bandwidth: 100 kHz

Pulse width: 3.0 s (90° pulse)

Pulse repetition time: 5.0 s

Reference material: C₆F₆ (external reference: −163.0 ppm)

Temperature: 22° C.

Sample rotation frequency: 25 kHz

(2) An integral value of a peak at around −78 ppm in the ¹⁹F-NMR spectrum obtained in (1) is calculated and is referred to as the amount α/2.

(3) As with the case of (2), an integral value of a peak at around −95 ppm in the ¹⁹F-NMR spectrum obtained in (1) is calculated and is referred to as the amount {(α/2)+β}.

(4) A content ratio (hereinafter, also referred to as “α ratio”) of the α-form PVDF-based resin with respect to 100 mol % of a total content of the α-form PVDF-based resin and a β-form PVDF-based resin is calculated, from the integral values obtained in (2) and (3), in accordance with the following Expression (ii).

a ratio (mol %)=[(integral value at around −78 ppm)×2/{(integral value at around −95 ppm)+(integral value at around −78 ppm)}]×100 (ii)

(5) A content ratio (hereinafter, also referred to as “β ratio”) of the β-form PVDF-based resin with respect to 100 mol % of the total content of the α-form PVDF-based resin and the β-form the PVDF-based resin is calculated, on the basis of the α ratio obtained in (4), in accordance with the following Expression (iii).

βratio (mol %)=100(mol %)−αratio (mol %) (iii)

(Method of Producing Porous Layer and Nonaqueous Electrolyte Secondary Battery Laminated Separator)

With regard to a method of producing the porous layer and the nonaqueous electrolyte secondary battery laminated separator for an embodiment of the present invention, the method is not limited to a particular one, and can be any of various methods.

In an example method, a porous layer containing a PVDF-based resin and optionally a filler is formed, through one of the processes (1) to (3) below, on a surface of a porous film as a base material. In the case of the process (2) or (3), a porous layer can be produced by drying a deposited porous layer for removal of a solvent. In the processes (1) to (3), a coating solution, in the case of production of a porous layer containing a filler, preferably contains the filler dispersed therein and the PVDF-based resin dissolved therein.

The coating solution for use in a method of producing a porous layer for an embodiment of the present invention can be prepared normally by (i) dissolving, in a solvent, a resin to be contained in the porous layer and (ii) dispersing, in the solvent, the filler to be contained in the porous layer.

(1) A process of forming a porous layer by (i) coating a surface of a porous film with a coating solution containing a PVDF-based resin to be contained in the porous layer and optionally a filler and (ii) drying the surface of the porous film so as to remove a solvent (dispersion medium) from the coating solution.

(2) A process of forming a porous layer by deposition, by (i) coating a surface of a porous film with the coating solution described above in the process (1) and then (ii) immersing the porous film in a deposition solvent, which is a poor solvent for the above PVDF-based resin.

(3) A process of forming a porous layer by deposition, by (i) coating a surface of a porous film with the coating solution described above in the process (1) and then (ii) acidifying the coating solution with use of a low-boiling-point organic acid.

Examples of a solvent (dispersion medium) in the above coating solution include N-methylpyrrolidone, N,N-dimethylacetamide, N,N-dimethylformamide, acetone, and water.

The deposition solvent is preferably isopropyl alcohol or t-butyl alcohol, for example.

For the process (3), the low-boiling-point organic acid can be, for example, paratoluene sulfonic acid or acetic acid.

The coating solution can contain, as a component other than the above-described resin and the filler, an appropriate amount of an additive(s) such as a disperser, a plasticizer, a surfactant, and a pH adjustor.

Note that the base material can be, other than the porous film, a film of another kind, a positive electrode plate, a negative electrode plate, or the like.

The coating solution can be applied to the base material by a conventionally known method. Specific examples of such a method include a gravure coater method, a dip coater method, a bar coater method, and a die coater method.

(Method of Controlling Crystal Forms of PVDF-Based Resin)

A crystal form of the PVDF-based resin contained in the porous layer for an embodiment of the present invention can be controlled by adjusting, in the above-described method, (i) drying conditions such as a drying temperature, and an air velocity and an air direction in drying, and/or (ii) a deposition temperature in a case where a porous layer containing a PVDF-based resin is deposited with use of a deposition solvent or a low-boiling-point organic acid.

In order to attain the PVDF-based resin arranged such that the content of the α-form PVDF-based resin is not less than 35.0 mol % with respect to 100 mol % of the total content of the α-form PVDF-based resin and the β-form PVDF-based resin in the PVDF-based resin, the drying conditions and the deposition temperature can be changed as appropriate in accordance with a method of producing a porous layer, a solvent (dispersion medium) as used, types of a deposition solvent and a low-boiling-point organic acid, and the like.

In a case where the coating solution is simply dried as in the process (1), the drying conditions can be changed as appropriate in accordance with, for example, the amount of the solvent in the coating solution, the concentration of the PVDF-based resin in the coating solution, the amount of the filler (if contained), and/or the amount of the coating solution to be applied. In a case where a porous layer is to be formed through the process (1) described above, it is preferable that the drying temperature be 30° C. to 100° C., that the direction of hot air for drying be perpendicular to a porous film or electrode sheet to which the coating solution has been applied, and that the velocity of the hot air be 0.1 m/s to 40 m/s. Specifically, in a case where a coating solution to be applied contains N-methyl-2-pyrrolidone as the solvent for dissolving a PVDF-based resin, 1.0% by mass of the PVDF-based resin, and 9.0% by mass of alumina as an inorganic filler, the drying conditions are preferably adjusted so that the drying temperature is 40° C. to 100° C., that the direction of hot air for drying is perpendicular to a porous film or electrode sheet to which the coating solution has been applied, and that the velocity of the hot air is 0.4 m/s to 40 m/s.

In a case where a porous layer is to be formed through the process (2) described above, it is preferable that the deposition temperature be −25° C. to 60° C. and that the drying temperature be 20° C. to 100° C. Specifically, in a case where a porous layer is to be formed through the above-described process (2) with use of (i) N-methylpyrrolidone as the solvent for dissolving a PVDF-based resin and (ii) isopropyl alcohol as the deposition solvent, it is preferable that the deposition temperature be −10° C. to 40° C. and that the drying temperature be 30° C. to 80° C.

(Another Porous Layer)

The nonaqueous electrolyte secondary battery in accordance with an embodiment of the present invention may contain another porous layer in addition to (i) the porous film and (ii) the porous layer which contains the PVDF-based resin. The another porous layer need only be provided between (i) the nonaqueous electrolyte secondary battery separator and (ii) at least one of the positive electrode plate and the negative electrode plate. The porous layer and the another porous layer may be provided in any order with respect to the nonaqueous electrolyte secondary battery separator. In a preferable configuration, the porous film, the another porous layer, and the porous layer which contains the PVDF-based resin are disposed in this order. In other words, the another porous layer is provided between the porous film and the porous layer which contains the PVDF-based resin. In another preferable configuration, the another porous layer and the porous layer which contains the PVDF-based resin are provided in this order on both surfaces of the porous film.

Further, the another porous layer for an embodiment of the present invention may contain, for example, any of polyolefins; (meth)acrylate-based resins; fluorine-containing resins (excluding polyvinylidene fluoride-based resins); polyamide-based resins; polyimide-based resins; polyester-based resins; rubbers; resins each having a melting point or a glass transition temperature of not lower than 180° C.; water-soluble polymers; and polycarbonate, polyacetal, and polyether ether ketone.

Among the above resins, polyolefins, (meth)acrylate-based resins, polyamide-based resins, polyester-based resins and water-soluble polymers are preferable.

Preferable examples of the polyolefins include polyethylene, polypropylene, polybutene, and an ethylene-propylene copolymer.

Examples of the fluorine-containing resins include polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer, and particularly fluorine-containing rubbers having a glass transition temperature of not higher than 23° C.

Preferable examples of the polyamide-based resins include aramid resins such as aromatic polyamides and wholly aromatic polyamides.

Specific examples of the aramid resins include poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Among those aramid resins, poly(paraphenylene terephthalamide) is more preferable.

The polyester-based resins are preferably aromatic polyesters such as polyarylates, and liquid crystal polyesters.

Examples of the rubbers include a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate.

Examples of the resins each having a melting point or a glass transition temperature of not lower than 180° C. include polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

The another porous layer may contain only one kind of the above resins or two or more kinds of the above resins in combination.

Other features (e.g., thickness) of the another porous layer are similar to those of the porous layer described in the above <Porous layer>, except that the porous layer contains the PVDF-based resin.

<Nonaqueous Electrolyte>

A nonaqueous electrolyte, which may be contained in a nonaqueous electrolyte secondary battery in accordance with an embodiment of the present invention, is not limited to any particular one, provided that the nonaqueous electrolyte is one that is generally used for a nonaqueous electrolyte secondary battery. The nonaqueous electrolyte can be, for example, a nonaqueous electrolyte containing, for example, an organic solvent and a lithium salt dissolved therein. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts or two or more kinds of the above lithium salts in combination.

Examples of the organic solvent to be contained in the nonaqueous electrolyte include carbonates, ethers, esters, nitriles, amides, carbamates, and sulfur-containing compounds, and fluorine-containing organic solvents each obtained by introducing a fluorine group into any of these organic solvents. It is possible to use only one kind of the above organic solvents or two or more kinds of the above organic solvents in combination.

<Method of Producing Nonaqueous Electrolyte Secondary Battery>

The nonaqueous electrolyte secondary battery in accordance with an embodiment of the present invention can be produced by, for example, (i) forming a member for a nonaqueous electrolyte secondary battery (hereinafter referred to as “nonaqueous electrolyte secondary battery member”) by disposing the positive electrode plate, the porous layer, the nonaqueous electrolyte secondary battery separator, and the negative electrode plate in this order, (ii) placing the nonaqueous electrolyte secondary battery member in a container which is to serve as a housing of the nonaqueous electrolyte secondary battery, (iii) filling the container with the nonaqueous electrolyte, and then (iv) hermetically sealing the container while reducing pressure inside the container.

The nonaqueous electrolyte secondary battery in accordance with an embodiment of the present invention includes a nonaqueous electrolyte secondary battery separator including a polyolefin porous film, a porous layer, a positive electrode plate, and a negative electrode plate, as described above. The nonaqueous electrolyte secondary battery in accordance with an embodiment of the present invention satisfies in particular the following requirements (i) to (iii).

(i) The polyvinylidene fluoride-based resin contained in the porous layer is arranged such that the content of the α-form polyvinylidene fluoride-based resin is not less than 35.0 mol % with respect to 100 mol % of the total content of the α-form polyvinylidene fluoride-based resin and the β-form polyvinylidene fluoride-based resin in the polyvinylidene fluoride-based resin.
(ii) In the folding endurance test, the number of bends of the positive electrode plate before peeling of the positive electrode active material layer is not less than 130.
(iii) In the folding endurance test, the number of bends of the negative electrode plate before peeling of the negative electrode active material layer is not less than 1650.

It is preferable that the nonaqueous electrolyte secondary battery in accordance with an embodiment of the present invention satisfy the following requirement (iv) in addition to the above requirements (i) to (iii).

(iv) The polyolefin porous film has a value of white index (WI) of not less than 85 and not more than 98, which whiteness index (WI) is defined in American Standard Test Methods E313.

Satisfying the requirement (i) prevents, in the nonaqueous electrolyte secondary battery in accordance with an embodiment of the present invention, (a) plastic deformation of a PVDF-based resin at a high temperature and (b) structural deformation of the porous layer and blockage of pores in the porous layer after charge and discharge under a high rate condition. Satisfying the requirements (ii) and (iii) allows an entire electrode to easily follow, in an isotropic manner, expansion and shrinkage of an active material. This makes it easy to keep cohesion of components contained inside an electrode active material layer and adhesion between the electrode active material layer and a current collector.

Accordingly, in a nonaqueous electrolyte secondary battery which satisfies the requirements (i) to (iii), (a) ion permeability of a porous layer is excellent since structural stability after charge and discharge under a high rate condition is excellent, and also, (b) degradation of the nonaqueous electrolyte secondary battery during a process of charge and discharge cycles is prevented since the above-described cohesion and adhesion are easily kept. On this account, it is considered that even after charge and discharge cycles are repeated (for example, after 100 cycles of charge and discharge), a charge capacity of the battery at C charge can be high after high-rate discharge of the battery.

Furthermore, in a nonaqueous electrolyte secondary battery satisfying the requirement (iv), (c) ion permeability of the polyolefin porous film increases, in addition to the above (a) and (b). This further prevents uneven capacity distribution in a direction of a surface of an electrode plate which uneven capacity distribution may occur due to a high-rate discharge. Presumably, this further improves a charge capacity of a battery at 1 C charge after high-rate discharge of the battery subsequent to cycles of high-rate charge and discharge of the battery.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss embodiments of the present invention in greater detail with reference to Examples and Comparative Examples. Note, however, that the present invention is not limited to the following Examples and Comparative Examples.

[Measurement Method]

In Examples and Comparative Examples, measurements were carried out by the following methods.

(1) Folding Endurance Test

A test piece having a size of length 105 mm×width 15 mm was cut out from a positive electrode plate or a negative electrode plate obtained in each of Examples and Comparative Examples below. The test piece was subjected to a folding endurance test according to the MIT tester method.

The folding endurance test was carried out, with use of an MIT type folding endurance tester (manufactured by YASUDA SEIKI SEISAKUSHO, LTD.), in conformity with the MIT tester method specified in JIS P 8115(1994). In the folding endurance test, one end of the test piece was fixed and the test piece was bent to right and left each at a bending angle of 45°, under the conditions of a load of 1 N, a bending portion radius R of 0.38 mm, and a bending speed of 175 reciprocations/min.

The number of bends was counted until an electrode active material layer peeled from the positive electrode plate or negative electrode plate. The number of bends here is the number of reciprocating bend motions which number is displayed on a counter of the MIT type folding endurance tester.

(2) Film Thickness (Unit: μm)

A thickness of each of a porous film, a positive electrode active material layer, and a negative electrode active material layer was measured with use of a high-precision digital measuring device (VL-50) manufactured by Mitutoyo Corporation. Note that the thickness of the positive electrode active material layer was calculated by subtracting a thickness of aluminum foil serving as a current collector from a thickness of the positive electrode plate. Meanwhile, the thickness of the negative electrode active material layer was calculated by subtracting a thickness of copper foil serving as a current collector from a thickness of the negative electrode plate.

(3) Whiteness Index (WI)

The WI value of the porous film was measured by a Specular Component Included (SCI) method (method including specular reflection in measurement) with use of a spectrocolorimeter (CM-2002, manufactured by MINOLTA). When measured, the porous film was placed on black paper (manufactured by Hokuetsu Kishu Paper Co., Ltd., colored high-quality paper, black, thickest type, shirokuhan tate me (788 mm×1091 mm paper having a vertical grain direction).

(4) Method of Calculating a Ratio

A test piece having a size of approximately 2 cm×5 cm was cut out from a laminated separator obtained in Examples and Comparative Examples below. The content ratio (a ratio) of an α-form PVDF-based resin in a PVDF-based resin contained in the test piece of the laminated separator thus cut out was measured according to the steps (1) to (4) of a procedure described in (Method of calculating content ratios of α-form PVDF-based resin and β-form PVDF-based resin in PVDF-based resin) above.

(5) 1 C charge capacity after high-rate discharge subsequent to 100 cycles of charge and discharge (hereinafter, referred to simply as “battery characteristic”)

a. Initial Charge and Discharge

A new nonaqueous electrolyte secondary battery, which had been produced in each of Examples and Comparative Examples but had not been subjected to any charge and discharge cycle, was subjected to four cycles of initial charge and discharge at 25° C. Each of the four cycles of the initial charge and discharge was carried out at a voltage ranging from 2.7 V to 4.1 V, with CC-CV charge at a charge current value of 0.2 C (terminal current condition: 0.02 C) and with CC discharge at a discharge current value of 0.2 C. An electric current value at which a battery rated capacity derived from a one-hour rate discharge capacity is discharged in one hour is defined as 1 C. Note that the “CC-CV charge” is a charging method in which (i) a battery is charged at a set constant electric current, and (ii) after a certain voltage is reached, the certain voltage is maintained while the electric current is being reduced. Note also that the “CC discharge” is a discharging method in which a battery is discharged at a set constant electric current until a certain voltage is reached. The same applies to the following description.

b. High Rate Cycle Test

The nonaqueous electrolyte secondary battery, which had been subjected to the above initial charge and discharge cycles, was subjected to 100 cycles of charge and discharge at 55° C. Each of the 100 cycles of charge and discharge was carried out at a voltage ranging from 2.7 V to 4.2 V, with CC-CV charge at a charge current value of 1 C (terminal current condition: 0.02 C) and with CC discharge at a discharge current value of 10 C.

c. Measurement of charging characteristic after high-rate discharge subsequent to 100 cycles of high-rate charge and discharge

The nonaqueous electrolyte secondary battery, which had been subjected to the above 100 cycles of charge and discharge, was subjected to cycles of charge and discharge at 55° C. Each of the cycles of charge and discharge this time was carried out at a voltage ranging from 2.7 V to 4.2 V, with CC-CV charge at a charge current value of 1 C (terminal current condition: 0.02 C) and with CC discharge at discharge current values varied in this order: 0.2 C, 1 C, 5 C, and 10 C. At each rate of the CC discharge, three cycles of charge and discharge was carried out at 55° C.

Subsequently, in a test at a discharge current value of 10 C, a 1 C charge capacity was measured after the above high-rate discharge at 10 C which was carried out after the above 100 cycles of charge and discharge. Then, a value obtained by dividing the 1 C charge capacity by a weight of the positive electrode active material was defined as a 1 C charge capacity after high-rate charge and discharge cycles.

### Example 1

[Production of Nonaqueous Electrolyte Secondary Battery Laminated Separator]

Ultra-high molecular weight polyethylene powder (GUR2024, manufactured by Ticona Corporation) having a weight-average molecular weight of 4,970,000 and polyethylene wax (FNP-0115, manufactured by Nippon Seiro Co., Ltd.) having a weight-average molecular weight of 1,000 were mixed for preparation of a mixture containing the ultra-high molecular weight polyethylene powder at a proportion of 68.0% by weight and the polyethylene wax at a proportion of 32.0% by weight. Then, 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate, with respect to 100 parts by weight of a total content of the ultra-high molecular weight polyethylene powder and the polyethylene wax of the mixture, were added to the 100 parts by weight of the mixture. Then, calcium carbonate having a BET specific surface area of 11.8 m²/g (manufactured by Maruo Calcium Co., Ltd.) was further added such that a volume of the calcium carbonate was 38% by volume with respect to the entire volume of a mixture obtained above by adding the antioxidants and the sodium stearate. Then, the resultant mixture was mixed as it was, that is, in the form of powder, in a Henschel mixer, and thereafter the mixture was melt-kneaded with use of a twin screw kneading extruder. This produced a polyolefin resin composition.

Next, the polyolefin resin composition was rolled with use of a pair of rollers each having a surface temperature of 150° C. This produced a sheet of the polyolefin resin composition. This sheet was immersed in an aqueous hydrochloric acid solution (containing 4 mol/L of hydrochloric acid and 1.0% by weight of nonionic surfactant) having a temperature of 43° C. for removal of the calcium carbonate, and was then cleaned with water at 45° C. Subsequently, the sheet thus cleaned was stretched 6.2-fold at 100° C. with use of a tenter uniaxial stretching machine manufactured by Ichikin Co., Ltd. This produced a porous film 1. The porous film 1 produced had a thickness of 10.0 μm, a weight per unit area of 6.4 g/m², and a WI value of 87.

An N-methyl-2-pyrrolidone (hereinafter referred to also as “NMP”) solution (manufactured by Kureha Corporation; product name: L#9305, weight-average molecular weight: 1,000,000) containing a PVDF-based resin (polyvinylidene fluoride-hexafluoropropylene copolymer) was prepared as a coating solution. The coating solution was applied by a doctor blade method to the porous film 1 so that the PVDF-based resin in the coating solution thus applied to the porous film 1 weighed 6.0 g per square meter of the porous film 1.

The porous film 1, to which the coating solution had been applied, was immersed into 2-propanol while the coating film was wet with the solvent, and was then left to stand still at −10° C. for 5 minutes while the porous film 1 was kept immersed in the 2-propanol. This produced a laminated porous film 1. The laminated porous film 1 produced was further immersed into other 2-propanol while the laminated porous film 1 was wet with the above immersion solvent, and was then left to stand still at 25° C. for 5 minutes while the laminated porous film 1 was kept immersed in that other 2-propanol. This produced a laminated porous film 1a. The laminated porous film 1a produced was dried at 130° C. for 5 minutes. This produced a laminated separator 1 including the porous film 1 and a porous layer disposed on the porous film 1. Table 1 shows results of evaluation of the laminated separator 1.

[Preparation of Nonaqueous Electrolyte Secondary Battery]

(Positive Electrode Plate)

A positive electrode plate was obtained which was arranged such that a layer of a positive electrode mix (a mixture of LiNi_{0.5}Mn_{0.3}Co_{0.2}O₂, an electrically conductive agent, and PVDF (at a weight ratio of 92:5:3)) was disposed on one surface of a positive electrode current collector (aluminum foil). Confining pressure (0.7 MPa) was applied to the positive electrode plate at room temperature for 30 seconds.

The positive electrode plate was cut so that (i) a first portion of the positive electrode plate, on which first portion a positive electrode active material layer was disposed, had a size of 45 mm×30 mm and (ii) a second portion of the positive electrode plate, on which second portion no positive electrode active material layer was disposed and which second portion had a width of 13 mm, remained on an outer periphery of the first portion. A resultant positive electrode plate was employed as a positive electrode plate 1. The positive electrode active material layer had a thickness of 38 μm.

(Negative Electrode Plate)

A negative electrode plate was obtained which was arranged such that a layer of a negative electrode mix (a mixture of natural graphite having an average particle diameter (D50) of 15 μm based on volume, a styrene-1,3-butadiene copolymer, and sodium carboxymethyl cellulose (at a weight ratio of 98:1:1)) was disposed on one surface of a negative electrode current collector (copper foil). Confining pressure (0.7 MPa) was applied to the negative electrode plate at room temperature for 30 seconds.

The negative electrode plate was cut so that (i) a first portion of the negative electrode plate, on which first portion a negative electrode active material layer was disposed, had a size of 50 mm×35 mm and (ii) a second portion of the negative electrode plate, on which second portion no negative electrode active material layer was disposed and which second portion had a width of 13 mm, remained on an outer periphery of the first portion. A resultant negative electrode plate was employed as a negative electrode plate 1. The negative electrode active material layer had a thickness of 38 μm.

(Assembly of Nonaqueous Electrolyte Secondary Battery)

A nonaqueous electrolyte secondary battery was produced by the following method with use of the positive electrode plate 1, the negative electrode plate 1, and the laminated separator 1.

The positive electrode plate 1, the laminated separator 1, and the negative electrode plate 1 were disposed (arranged) in this order in a laminate pouch, so that a nonaqueous electrolyte secondary battery member 1 was obtained. In so doing, the positive electrode plate 1 and the negative electrode plate 1 were arranged such that a main surface of the positive electrode active material layer of the positive electrode plate 1 was entirely included in a range of a main surface of the negative electrode active material layer of the negative electrode plate 1 (i.e., entirely covered by the main surface of the negative electrode active material layer of the negative electrode plate 1). Further, a surface of the laminated separator 1, which surface was on a porous layer side, was opposed to the positive electrode active material layer of the positive electrode plate 1.

Subsequently, the nonaqueous electrolyte secondary battery member 1 was put into a bag prepared in advance, which bag had been formed by a laminate of an aluminum layer and a heat seal layer. Further, 0.23 mL of a nonaqueous electrolyte was put into the bag. The above nonaqueous electrolyte was prepared by dissolving LiPF₆ in a mixed solvent of ethylene carbonate, ethyl methyl carbonate, and diethyl carbonate at a ratio of 3:5:2 (volume ratio) so that the LiPF₆ would be contained at 1 mol/L. The bag was then heat-sealed while the pressure inside the bag was reduced. This produced a nonaqueous electrolyte secondary battery 1.

Thereafter, the nonaqueous electrolyte secondary battery 1 obtained by the above method was subjected to measurement of battery characteristics. Table 1 shows results of the measurement.

### Example 2

[Production of Nonaqueous Electrolyte Secondary Battery Laminated Separator]

Ultra-high molecular weight polyethylene powder (GUR4032, manufactured by Ticona Corporation) having a weight-average molecular weight of 4,970,000 and polyethylene wax (FNP-0115, manufactured by Nippon Seiro Co., Ltd.) having a weight-average molecular weight of 1,000 were mixed for preparation of a mixture containing the ultra-high molecular weight polyethylene powder at a proportion of 70.0% by weight and the polyethylene wax at a proportion of 30.0% by weight. Then, 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate, with respect to 100 parts by weight of a total content of the ultra-high molecular weight polyethylene powder and the polyethylene wax of the mixture, were added to the 100 parts by weight of the mixture. Then, calcium carbonate having a BET specific surface area of 11.6 m²/g (manufactured by Maruo Calcium Co., Ltd.) was further added such that a volume of the calcium carbonate was 36% by volume with respect to the entire volume of a mixture obtained above by adding the antioxidants and the sodium stearate. Then, the resultant mixture was mixed as it was, that is, in the form of powder, in a Henschel mixer, and thereafter the mixture was melt-kneaded with use of a twin screw kneading extruder. This produced a polyolefin resin composition.

Next, the polyolefin resin composition was rolled with use of a pair of rollers each having a surface temperature of 150° C. This produced a sheet of the polyolefin resin composition. This sheet was immersed in an aqueous hydrochloric acid solution (containing 4 mol/L of hydrochloric acid and 6.0% by weight of nonionic surfactant) having a temperature of 38° C. for removal of the calcium carbonate, and was then cleaned with water at 40° C. Subsequently, the sheet thus cleaned was stretched 6.2-fold at 105° C. with use of a tenter uniaxial stretching machine manufactured by Ichikin Co., Ltd. This produced a porous film 2. The porous film 2 produced had a thickness of 15.6 μm, a weight per unit area of 5.4 g/m², and a WI value of 97.

Then, a surface of the porous film 2 was coated with a coating solution as in Example 1. The porous film 2, to which the coating solution had been applied, was immersed into 2-propanol while the coating film was wet with the solvent, and was then left to stand still at 25° C. for 5 minutes while the porous film 2 was kept immersed in the 2-propanol. This produced a laminated porous film 2. The laminated porous film 2 produced was further immersed into other 2-propanol while the laminated porous film 2 was wet with the above immersion solvent, and was then left to stand still at 25° C. for 5 minutes while the laminated porous film 2 was kept immersed in that other 2-propanol. This produced a laminated porous film 2a. The laminated porous film 2a produced was dried at 65° C. for 5 minutes. This produced a laminated separator 2 including the porous film 2 and a porous layer disposed on the porous film 2. Table 1 shows results of evaluation of the laminated separator 2.

[Preparation of Nonaqueous Electrolyte Secondary Battery]

A nonaqueous electrolyte secondary battery was prepared as in Example 1, except that the laminated separator 2 was used in place of the laminated separator 1. The nonaqueous electrolyte secondary battery thus prepared was referred to as a nonaqueous electrolyte secondary battery 2.

Thereafter, the nonaqueous electrolyte secondary battery 2 obtained by the above method was subjected to measurement of battery characteristics. Table 1 shows results of the measurement.

### Example 3

[Production of Nonaqueous Electrolyte Secondary Battery Laminated Separator]

Ultra-high molecular weight polyethylene powder (GUR4032, manufactured by Ticona Corporation) having a weight-average molecular weight of 4,970,000 and polyethylene wax (FNP-0115, manufactured by Nippon Seiro Co., Ltd.) having a weight-average molecular weight of 1,000 were mixed for preparation of a mixture containing the ultra-high molecular weight polyethylene powder at a proportion of 71.5% by weight and the polyethylene wax at a proportion of 28.5% by weight. Then, 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate, with respect to 100 parts by weight of a total content of the ultra-high molecular weight polyethylene powder and the polyethylene wax of the mixture, were added to the 100 parts by weight of the mixture. Then, calcium carbonate having a BET specific surface area of 11.8 m²/g (manufactured by Maruo Calcium Co., Ltd.) was further added such that a volume of the calcium carbonate was 37% by volume with respect to the entire volume of a mixture obtained above by adding the antioxidants and the sodium stearate. Then, the resultant mixture was mixed as it was, that is, in the form of powder, in a Henschel mixer, and thereafter the mixture was melt-kneaded with use of a twin screw kneading extruder. This produced a polyolefin resin composition.

Next, the polyolefin resin composition was rolled with use of a pair of rollers each having a surface temperature of 150° C. This produced a sheet of the polyolefin resin composition. This sheet was immersed in an aqueous hydrochloric acid solution (containing 4 mol/L of hydrochloric acid and 1.0% by weight of nonionic surfactant) having a temperature of 43° C. for removal of the calcium carbonate, and was then cleaned with water at 45° C. Subsequently, the sheet thus cleaned was stretched 7.0-fold at 100° C. with use of a tenter uniaxial stretching machine manufactured by Ichikin Co., Ltd. This produced a porous film 3. The porous film 3 produced had a thickness of 10.3 μm, a weight per unit area of 5.2 g/m², and a WI value of 91.

Then, a surface of the porous film 3 was coated with a coating solution as in Example 1. The porous film 3, to which the coating solution had been applied, was immersed into 2-propanol while the coating film was wet with the solvent, and was then left to stand still at −5° C. for 5 minutes while the porous film 3 was kept immersed in the 2-propanol. This produced a laminated porous film 3. The laminated porous film 3 produced was further immersed into other 2-propanol while the laminated porous film 3 was wet with the above immersion solvent, and was then left to stand still at 25° C. for 5 minutes while the laminated porous film 3 was kept immersed in that other 2-propanol. This produced a laminated porous film 3a. The laminated porous film 3a produced was dried at 30° C. for 5 minutes. This produced a laminated separator 3 including the porous film 3 and a porous layer disposed on the porous film 3. Table 1 shows results of evaluation of the laminated separator 3.

[Preparation of Nonaqueous Electrolyte Secondary Battery]

A nonaqueous electrolyte secondary battery was prepared as in Example 1, except that the laminated separator 3 was used in place of the laminated separator 1. The nonaqueous electrolyte secondary battery thus prepared was referred to as a nonaqueous electrolyte secondary battery 3.

Thereafter, the nonaqueous electrolyte secondary battery 3 obtained by the above method was subjected to measurement of battery characteristics. Table 1 shows results of the measurement.

### Example 4

(Positive Electrode Plate)

A positive electrode plate was obtained which was arranged such that a layer of a positive electrode mix (a mixture of LiNi_{0.5}Mn_{0.3}Co_{0.2}O₂, an electrically conductive agent, and PVDF (at a weight ratio of 92:5:3)) was disposed on one surface of a positive electrode current collector (aluminum foil). Confining pressure (0.7 MPa) was applied to the positive electrode plate at room temperature for 30 seconds while the positive electrode plate was wet with diethyl carbonate.

The positive electrode plate was cut so that (i) a first portion of the positive electrode plate, on which first portion a positive electrode active material layer was disposed, had a size of 45 mm×30 mm and (ii) a second portion of the positive electrode plate, on which second portion no positive electrode active material layer was disposed and which second portion had a width of 13 mm, remained on an outer periphery of the first portion. A resultant positive electrode plate was employed as a positive electrode plate 2. The positive electrode active material layer had a thickness of 37 μm.

[Preparation of Nonaqueous Electrolyte Secondary Battery]

A nonaqueous electrolyte secondary battery was prepared as in Example 1, except that the laminated separator 3 was used in place of the laminated separator 1 and that the positive electrode plate 2 was used as a positive electrode plate. The nonaqueous electrolyte secondary battery thus prepared was referred to as a nonaqueous electrolyte secondary battery 4.

Thereafter, the nonaqueous electrolyte secondary battery 4 obtained by the above method was subjected to measurement of battery characteristics. Table 1 shows results of the measurement.

### Example 5

(Positive Electrode Plate)

A positive electrode plate was obtained which was arranged such that a layer of a positive electrode mix (a mixture of LiCoO₂, an electrically conductive agent, and PVDF (at a weight ratio of 100:5:3)) was disposed on one surface of a positive electrode current collector (aluminum foil). Confining pressure (0.7 MPa) was applied to the positive electrode plate at room temperature for 30 seconds while the positive electrode plate was wet with diethyl carbonate.

The positive electrode plate was cut so that (i) a first portion of the positive electrode plate, on which first portion a positive electrode active material layer was disposed, had a size of 45 mm×30 mm and (ii) a second portion of the positive electrode plate, on which second portion no positive electrode active material layer was disposed and which second portion had a width of 13 mm, remained on an outer periphery of the first portion. A resultant positive electrode plate was employed as a positive electrode plate 3. The positive electrode active material layer had a thickness of 38 μm.

[Preparation of Nonaqueous Electrolyte Secondary Battery]

A nonaqueous electrolyte secondary battery was prepared as in Example 1, except that the laminated separator 3 was used in place of the laminated separator 1 and that the positive electrode plate 3 was used as a positive electrode plate. The nonaqueous electrolyte secondary battery thus prepared was referred to as a nonaqueous electrolyte secondary battery 5.

Thereafter, the nonaqueous electrolyte secondary battery 5 obtained by the above method was subjected to measurement of battery characteristics. Table 1 shows results of the measurement.

### Example 6

(Negative Electrode Plate)

A negative electrode plate was obtained which was arranged such that a layer of a negative electrode mix (a mixture of natural graphite, a styrene-1,3-butadiene copolymer, and sodium carboxymethyl cellulose (at a weight ratio of 98:1:1)) was disposed on one surface of a negative electrode current collector (copper foil). Confining pressure (0.7 MPa) was applied to the negative electrode plate at room temperature for 30 seconds while the negative electrode plate was wet with diethyl carbonate.

The negative electrode plate was cut so that (i) a first portion of the negative electrode plate, on which first portion a negative electrode active material layer was disposed, had a size of 50 mm×35 mm and (ii) a second portion of the negative electrode plate, on which second portion no negative electrode active material layer was disposed and which second portion had a width of 13 mm, remained on an outer periphery of the first portion. A resultant negative electrode plate was employed as a negative electrode plate 2. The negative electrode active material layer had a thickness of 37 μm.

[Preparation of Nonaqueous Electrolyte Secondary Battery]

A nonaqueous electrolyte secondary battery was prepared as in Example 1, except that the laminated separator 3 was used in place of the laminated separator 1 and that the negative electrode plate 2 was used as a negative electrode plate. The nonaqueous electrolyte secondary battery thus prepared was referred to as a nonaqueous electrolyte secondary battery 6.

Thereafter, the nonaqueous electrolyte secondary battery 6 obtained by the above method was subjected to measurement of battery characteristics. Table 1 shows results of the measurement.

### Example 7

(Negative Electrode Plate)

A negative electrode plate was obtained which was arranged such that a layer of a negative electrode mix (a mixture of artificial spherocrystal graphite, an electrically conductive agent, and PVDF (at a weight ratio of 85:15:7.5)) was disposed on one surface of a negative electrode current collector (copper foil). Confining pressure (0.7 MPa) was applied to the negative electrode plate at room temperature for 30 seconds while the negative electrode plate was wet with diethyl carbonate.

The negative electrode plate was cut so that (i) a first portion of the negative electrode plate, on which first portion a negative electrode active material layer was disposed, had a size of 50 mm×35 mm and (ii) a second portion of the negative electrode plate, on which second portion no negative electrode active material layer was disposed and which second portion had a width of 13 mm, remained on an outer periphery of the first portion. A resultant negative electrode plate was employed as a negative electrode plate 3. The negative electrode active material layer had a thickness of 36 μm.

[Preparation of Nonaqueous Electrolyte Secondary Battery]

A nonaqueous electrolyte secondary battery was prepared as in Example 1, except that the laminated separator 3 was used in place of the laminated separator 1 and that the negative electrode plate 3 was used as a negative electrode plate. The nonaqueous electrolyte secondary battery thus prepared was referred to as a nonaqueous electrolyte secondary battery 7.

Thereafter, the nonaqueous electrolyte secondary battery 7 obtained by the above method was subjected to measurement of battery characteristics. Table 1 shows results of the measurement.

### Example 8

[Preparation of Porous Layer and Laminated Separator]

In N-methyl-2-pyrrolidone, a PVDF-based resin (manufactured by Arkema Inc.; product name “Kynar (registered trademark) LBG”; weight-average molecular weight of 590,000) was stirred and dissolved at 65° C. for 30 minutes so that a solid content was 10% by mass. A resultant solution was used as a binder solution. As a filler, alumina fine particles (manufactured by Sumitomo Chemical Co., Ltd.; product name “AKP3000”; containing 5 ppm of silicon) was used. The alumina fine particles, the binder solution, and a solvent (N-methyl-2-pyrrolidone) were mixed together so as to be in the following proportion. That is, the alumina fine particles, the binder solution, and the solvent were mixed together so that (i) a resultant mixed solution contained 10 parts by weight of the PVDF-based resin with respect to 90 parts by weight of the alumina fine particles, and (ii) a solid content concentration (alumina fine particles+PVDF-based resin) of the mixed solution was 10% by weight. A dispersion solution was thus obtained. The dispersion solution was applied as a coating solution by a doctor blade method to the porous film 3, which was prepared in Example 3, so that the PVDF-based resin in the coating solution thus applied to the porous film 3 weighed 6.0 g per square meter of the porous film 3. This produced a laminated porous film 4. The laminated porous film 4 produced was dried at 65° C. for 5 minutes. This produced a laminated separator 4 including the porous film 3 and a porous layer disposed on the porous film 3. The direction of hot air for drying here was arranged to be perpendicular to a base material and the velocity of the hot air for the drying was set to 0.5 m/s. Table 1 shows results of evaluation of the laminated separator 4.

[Preparation of Nonaqueous Electrolyte Secondary Battery]

A nonaqueous electrolyte secondary battery was prepared as in Example 1, except that the laminated separator 4 was used in place of the laminated separator 1. The nonaqueous electrolyte secondary battery thus prepared was referred to as a nonaqueous electrolyte secondary battery 8.

Thereafter, the nonaqueous electrolyte secondary battery 8 obtained by the above method was subjected to measurement of battery characteristics. Table 1 shows results of the measurement.

### Comparative Example 1

[Preparation of Nonaqueous Electrolyte Secondary Battery Laminated Separator]

A porous film 3, which has been produced as in Example 3 and to which a coating solution had been applied as in Example 3, was immersed into 2-propanol while the coating film was wet with the solvent, and was then left to stand still at −78° C. for 5 minutes while the porous film 3 was kept immersed in the 2-propanol. This produced a laminated porous film 5. The laminated porous film 5 produced was further immersed into other 2-propanol while the laminated porous film 5 was wet with the above immersion solvent, and was then left to stand still at 25° C. for 5 minutes while the laminated porous film 5 was kept immersed in that other 2-propanol. This produced a laminated porous film 5a. The laminated porous film 5a produced was dried at 30° C. for 5 minutes. This produced a laminated separator 5 including the porous film 3 and a porous layer disposed on the porous film 3. Table 1 shows results of evaluation of the laminated separator 5.

[Preparation of Nonaqueous Electrolyte Secondary Battery]

A nonaqueous electrolyte secondary battery was prepared as in Example 1, except that the laminated separator 5 was used in place of the laminated separator 1. The nonaqueous electrolyte secondary battery thus prepared was referred to as a nonaqueous electrolyte secondary battery 9.

Thereafter, the nonaqueous electrolyte secondary battery 9 obtained by the above method was subjected to measurement of battery characteristics. Table 1 shows results of the measurement.

### Comparative Example 2

(Positive Electrode Plate)

A positive electrode plate was obtained which was arranged such that a layer of a positive electrode mix (a mixture of LiNi_{0.5}Mn_{0.3}Co_{0.2}O₂, an electrically conductive agent, and PVDF (at a weight ratio of 92:5:3)) was disposed on one surface of a positive electrode current collector (aluminum foil).

The positive electrode plate was cut so that (i) a first portion of the positive electrode plate, on which first portion a positive electrode active material layer was disposed, had a size of 45 mm×30 mm and (ii) a second portion of the positive electrode plate, on which second portion no positive electrode active material layer was disposed and which second portion had a width of 13 mm, remained on an outer periphery of the first portion. A resultant positive electrode plate was employed as a positive electrode plate 4. The positive electrode active material layer had a thickness of 38 μm.

[Preparation of Nonaqueous Electrolyte Secondary Battery]

A nonaqueous electrolyte secondary battery was prepared as in Example 1, except that the laminated separator 3 was used in place of the laminated separator 1 and that the positive electrode plate 4 was used as a positive electrode plate. The nonaqueous electrolyte secondary battery thus prepared was referred to as a nonaqueous electrolyte secondary battery 10.

Thereafter, the nonaqueous electrolyte secondary battery 10 obtained by the above method was subjected to measurement of battery characteristics. Table 1 shows results of the measurement.

### Comparative Example 3

(Negative Electrode Plate)

A negative electrode plate was obtained which was arranged such that a layer of a negative electrode mix (a mixture of natural graphite, a styrene-1,3-butadiene copolymer, and sodium carboxymethyl cellulose (at a weight ratio of 98:1:1)) was disposed on one surface of a negative electrode current collector (copper foil).

The negative electrode plate was cut so that (i) a first portion of the negative electrode plate, on which first portion a negative electrode active material layer was disposed, had a size of 50 mm×35 mm and (ii) a second portion of the negative electrode plate, on which second portion no negative electrode active material layer was disposed and which second portion had a width of 13 mm, remained on an outer periphery of the first portion. A resultant negative electrode plate was employed as a negative electrode plate 4. The negative electrode active material layer had a thickness of 38 μm.

[Preparation of Nonaqueous Electrolyte Secondary Battery]

A nonaqueous electrolyte secondary battery was prepared as in Example 1, except that the laminated separator 3 was used in place of the laminated separator 1 and that the negative electrode plate 4 was used as a negative electrode plate. The nonaqueous electrolyte secondary battery thus prepared was referred to as a nonaqueous electrolyte secondary battery 11.

Thereafter, the nonaqueous electrolyte secondary battery 11 obtained by the above method was subjected to measurement of battery characteristics. Table 1 shows results of the measurement.

TABLE 1

| | | Electrodes | | |
|---|---|---|---|---|
| | | Positive | Negative | Effect |
| | | electrode | electrode | 1 C charge |
| | | The number | The number | capacity |
| | Laminated | of bends | of bends | after high-rate |
| | separator | before | before | discharge |
| | Porous | peeling of | peeling of | subsequent to |
| | layer | electrode | electrode | high-rate |
| | α-form | active | active | charge and |
| | PVDF | material | material | discharge cycles |
| | ratio | layer | layer | (mAh/g) |
| Example 1 | 59.6 | 164 | 1732 | 101 |
| Example 2 | 80.8 | 164 | 1732 | 111 |
| Example 3 | 44.4 | 164 | 1732 | 101 |
| Example 4 | 44.4 | 177 | 1732 | 101 |
| Example 5 | 44.4 | 210 | 1732 | 99 |
| Example 6 | 44.4 | 164 | 1858 | 115 |
| Example 7 | 44.4 | 164 | 2270 | 126 |
| Example 8 | 64.3 | 164 | 1732 | 112 |
| Comparative | 34.6 | 164 | 1732 | 58 |
| Example 1 | | | | |
| Comparative | 44.4 | 126 | 1732 | 81 |
| Example 2 | | | | |
| Comparative | 44.4 | 164 | 1633 | 78 |
| Example 3 | | | | |

As shown in Table 1, the nonaqueous electrolyte secondary batteries produced in Examples 1 to 8 each had a better charge capacity characteristic after high-rate discharge subsequent to repeated high-rate charge and discharge cycles, as compared to the nonaqueous electrolyte secondary batteries produced in Comparative Examples 1 to 3.

It is therefore clear from the above that a nonaqueous electrolyte secondary battery can have a better charge capacity characteristic after high-rate discharge subsequent to repeated high-rate charge and discharge cycles, when the nonaqueous electrolyte secondary battery satisfies the following three requirements: (i) the polyvinylidene fluoride-based resin contained in the porous layer is arranged such that the content of the α-form polyvinylidene fluoride-based resin is not less than 35.0 mol % with respect to 100 mol % of the total content of the α-form polyvinylidene fluoride-based resin and the β-form polyvinylidene fluoride-based resin in the polyvinylidene fluoride-based resin; (ii) in the folding endurance test, the number of bends of the positive electrode plate before peeling of the positive electrode active material layer is not less than 130; and (iii) in the folding endurance test, the number of bends of the negative electrode plate before peeling of the negative electrode active material layer is not less than 1650.

### Reference Example 1

(Positive Electrode Plate)

A positive electrode plate was obtained which was arranged such that a layer of a positive electrode mix (a mixture of LiNi_{0.5}Mn_{0.3}Co_{0.2}O₂, an electrically conductive agent, and PVDF (at a weight ratio of 92:5:3)) was disposed on one surface of a positive electrode current collector (aluminum foil). With respect to the positive electrode plate, a pressure of 40 MPa was applied at room temperature by a roll press machine. This produced a positive electrode plate A.

(Negative Electrode Plate)

A negative electrode plate was obtained which was arranged such that a layer of a negative electrode mix (a mixture of natural graphite having an average particle diameter (D50) of 15 μm based on volume, a styrene-1,3-butadiene copolymer, and sodium carboxymethyl cellulose (at a weight ratio of 98:1:1)) was disposed on one surface of a negative electrode current collector (copper foil). With respect to the negative electrode plate, a pressure of 40 MPa was applied at room temperature by a roll press machine. This produced a negative electrode plate A.

The positive electrode plate A and the negative electrode plate A were each subjected to the above-described folding endurance test. As a result, the number of bends of the positive electrode plate A before peeling of a positive electrode active material layer was 64 and the number of bends of the negative electrode plate before peeling of a negative electrode active material layer was 1325.

In other words, it was found that when a pressure applied in production of an electrode plate is too high, a resultant electrode plate may not satisfy the above-described requirements for the number of bends.

### INDUSTRIAL APPLICABILITY

A nonaqueous electrolyte secondary battery in accordance with an embodiment of the present invention has an excellent charge capacity characteristic after high-rate discharge subsequent to repeated high-rate charge and discharge cycles. The nonaqueous electrolyte secondary battery is therefore suitable for use as (i) batteries for use in devices such as a personal computer, a mobile telephone, and a portable information terminal and (ii) on-vehicle batteries.

1. A nonaqueous electrolyte secondary battery comprising:
a nonaqueous electrolyte secondary battery separator including a polyolefin porous film;
a porous layer containing a polyvinylidene fluoride-based resin;
a positive electrode plate, a bend number of which being not less than 130, the bend number indicating how many times the positive electrode plate bends before peeling of a positive electrode active material layer occurs in a folding endurance test according to an MIT tester method specified in JIS P 8115 (1994), the folding endurance test being carried out under conditions of a load of 1 N and a bending angle of 45°; and
a negative electrode plate, a bend number of which being not less than 1650, the bend number indicating how many times the negative electrode plate bends before peeling of a negative electrode active material layer occurs in the folding endurance test,
the porous layer being provided between the nonaqueous electrolyte secondary battery separator and at least one of the positive electrode plate and the negative electrode plate,
the polyvinylidene fluoride-based resin contained in the porous layer containing an α-form polyvinylidene fluoride-based resin and a β-form polyvinylidene fluoride-based resin,
a content of the α-form polyvinylidene fluoride-based resin being not less than 35.0 mol % with respect to 100 mol % of a total content of the α-form polyvinylidene fluoride-based resin and the β-form polyvinylidene fluoride-based resin in the polyvinylidene fluoride-based resin,
the content of the α-form polyvinylidene fluoride-based resin being calculated by (a) waveform separation of (α/2) observed at around −78 ppm in a ¹⁹F-NMR spectrum obtained from the porous layer and (b) waveform separation of {(α/2)+β} observed at around −95 ppm in the ¹⁹F-NMR spectrum obtained from the porous layer.

2. The nonaqueous electrolyte secondary battery as set forth in claim 1, wherein the positive electrode plate contains a transition metal oxide.

3. The nonaqueous electrolyte secondary battery as set forth in claim 1, wherein the negative electrode plate contains graphite.

4. The nonaqueous electrolyte secondary battery as set forth in claim 1, further comprising:
another porous layer which is provided between (i) the nonaqueous electrolyte secondary battery separator and (ii) at least one of the positive electrode plate and the negative electrode plate.

5. The nonaqueous electrolyte secondary battery as set forth in claim 4, wherein the another porous layer contains at least one kind of resin selected from the group consisting of polyolefins, (meth)acrylate-based resins, fluorine-containing resins (excluding polyvinylidene fluoride-based resins), polyamide-based resins, polyester-based resins and water-soluble polymers.

6. The nonaqueous electrolyte secondary battery as set forth in claim 5, wherein the polyamide-based resin is an aramid resin.
